(19) United States
(12) Patent Application Publication
(10) Pub. No.: US 2003/0189168 A1
(43) Pub. Date: Oct. 9, 2003

(54) Fragmentation of ions by resonant excitation in a low pressure ion trap

(76) Inventors: Frank Londry, Peterborough (CA); Bruce A. Collings, Bradford (CA); William R. Stott, King City (CA)

Correspondence Address: BARNES & THORNBURG, P.O. BOX 2786, CHICAGO, IL, 60690-2786, US

(21) Appl. No.: 10/310,000

(22) Filed: Dec. 4, 2002

Related U.S. Application Data
(60) Provisional application No. 60/370,205, filed on Apr. 5, 2002.

(51) Int. Cl. H01J 49/42

(52) U.S. Cl. 250/282; 250/292

(57) ABSTRACT

In the field of mass spectrometry, a method and apparatus for fragmenting ions with a relatively high degree of resolution. The technique includes trapping the ions in an ion trap, preferably a linear ion trap, in which the background or neutral gas pressure is preferably on the order of 10⁻⁵ Torr. The trapped ions are resonantly excited for a relatively extended period of time, e.g., exceeding 50 ms, at relatively low excitation levels, e.g., less than 1V₍₀₋ₚₖ₎. The technique allows selective dissociation of ions with a discrimination of at least about 1 m/z at a practical fragmentation efficiencies. Apparatus and related methods are also disclosed for obtaining MS, MS², MS³ and MSⁿ spectrums at relatively high resolutions using the low pressure fragmentation technique.

### CROSS-REFERENCE TO RELATED APPLICATIONS

This application claims priority from U.S. Provisional Patent Application No. 60/370,205 filed Apr. 5, 2002 and entitled “Fragmentation of Ions by Resonant Excitation in a Low Pressure Ion Trap.”

### FIELD OF INVENTION

The invention relates to mass spectrometers, and more particularly to a mass spectrometer capable of fragmenting ions with relatively high discrimination.

### BACKGROUND OF INVENTION

Tandem mass spectrometry techniques typically involve the detection of ions that have undergone physical change(s) in a mass spectrometer. Frequently, the physical change involves dissociating or fragmenting a selected precursor or parent ion and recording the mass spectrum of the resultant fragment or child ions. The information in the fragment ion mass spectrum is often a useful aid in elucidating the structure of the precursor or parent ion. For example, the general approach used to obtain a mass spectrometry/mass spectrometry (MS/MS or MS²) spectrum is to isolate a selected precursor or parent ion with a suitable m/z analyzer, subject the precursor or parent ion to energetic collisions with a neutral gas in order to induce dissociation, and finally to mass analyze the fragment or child ions in order to generate a mass spectrum.

An additional stage of MS can be applied to the MS/MS scheme outlined above, giving MS/MS/MS or MS³. This additional stage can be quite useful to elucidate dissociation pathways, particularly if the MS² spectrum is very rich in fragment ion peaks or is dominated by primary fragment ions with little structural information. MS³ offers the opportunity to break down the primary fragment ions and generate additional or secondary fragment ions that often yield the information of interest. Indeed, the technique can be carried out n times to provide an MSⁿ spectrum.

Ions are typically fragmented or dissociated in some form of a collision cell where the ions are caused to collide with an inert gas. Dissociation is induced either because the ions are injected into the cell with a high axial energy or by application of an external excitation. See, for example, WIPO publication WO 00/33350 dated Jun. 8, 2000 by Douglas et al.

Douglas discloses a triple quadrupole mass spectrometer wherein the middle quadrupole is configured as a relatively high pressure collision cell in which ions are trapped. This offers the opportunity to both isolate and fragment a chosen ion using resonant excitation techniques. The problem with the Douglas system is that the ability to isolate and fragment a specific ion within the collision cell is relatively low. To compensate for this, Douglas uses the first quadrupole as a mass filter to provide high resolution in the selection of precursor ions, which enables an MS² spectrum to be recorded with relatively high accuracy. However, to produce an MS³ (or higher) spectrum, isolation and fragmentation must be carried out in the limited-resolution collision cell.

### SUMMARY OF INVENTION

Generally speaking, the invention provides a method and apparatus for fragmenting ions in an ion trap with a relatively high degree of resolution. This is accomplished by maintaining an inert or background gas in the trap at a pressure lower than that of conventional collision cells. The pressure in the trap is thus on the order of 10⁻⁴ Torr or less, and preferably on the order of 10⁻⁵ Torr. The trapped ions are resonantly excited at a relatively low excitation amplitude, for a relatively extended period of time, preferably exceeding 25 ms. Ions can thus be selectively dissociated or fragmented with a relatively high discrimination. For example, a discrimination of at least about 1 m/z was obtained at m/z=609.

According to one aspect of the invention a method is provided for analyzing a substance. The method includes (a) providing an ion trap having a background gas pressure of less than approximately 9×10⁻⁵ Torr; (b) ionizing the substance to provide a stream of ions; (c) trapping at least a portion of the ion stream in the trap; (d) resonantly exciting selected trapped ions in order to promote collision-induced dissociation of the selected ions; and (e) thereafter mass analyzing the trapped ions to generate a mass spectrum. The resonant excitation is preferably accomplished by subjecting the ions to an alternating potential for an excitation period exceeding approximately 25 ms.

According to another aspect of the invention a method of fragmenting ions is provided. The method includes (a) trapping ions in an ion trap by subjecting the ions to an RF alternating potential, the trap being disposed in an environment in which a background gas is present at a pressure on the order of 10⁻⁵ Torr; and (b) resonantly exciting trapped ions of a selected m/z value by applying to at least one set of poles straddling the trapped ions an auxiliary alternating excitation signal for a period exceeding approximately 25 milliseconds, to thereby promote collision-induced dissociation of the selected ions.

According to another aspect of the invention a method of mass analyzing a stream of ions to obtain an MS² spectrum is provided. The method includes: (a) subjecting a stream of ions to a first mass filter step, to select precursor ions having a mass-to-charge ratio in a first desired range; (b) trapping the precursor ions in a linear ion trap by subjecting the ions to an RF alternating potential; (c) resonantly exciting the trapped precursor ions by subjecting them to an auxiliary alternating potential for an excitation period exceeding approximately 25 milliseconds under a background gas pressure on the order of 10⁻⁵ Torr, to thereby generate fragment ions; and (d) mass analyzing the trapped ions to generate a mass spectrum.

According to yet another aspect of the invention a method of mass analyzing a stream of ions to obtain an MS³ spectrum is provided. The method includes: (a) subjecting a stream of ions to a first mass filter step, to select precursor ions having a mass-to-charge ratio in a first desired range; (b) fragmenting the precursor ions in a collision cell, to thereby produce a first generation of fragment ions; (c) trapping any un-dissociated precursor ions and the first generation of fragment ions in a linear ion trap by subjecting the ions to an RF alternating potential, subjecting the trapped ions to a second mass filter step to thereby isolate ions having an m/z value(s) in a second desired range, and resonantly exciting at least a portion of the first generation ions by subjecting them to an auxiliary alternating potential for an excitation period exceeding approximately 25 milliseconds under a background gas pressure on the order of 10⁻⁵ Torr, to thereby generate a second generation of fragment ions; and (d) mass analyzing the trapped ions to generate a mass spectrum.

According to still another aspect of the invention a mass spectrometer is provided. The mass spectrometer includes a linear ion trap for trapping ions spatially. At least one set of poles straddle at least a portion of trapped ions. The poles may form part of the structure of the ion trap, or they may be provided as extraneous poles. The background gas in the trap is at a pressure of less than approximately 9×10⁻⁵ Torr. Means are provided for introducing ions into the trap. An alternating voltage source applies to the at least one of set of poles a resonant excitation signal for a period exceeding approximately 25 milliseconds, thereby to promote collision-induced dissociation of selected ions. Means are also provided for mass analyzing the trapped ions to generate a mass spectrum.

According to yet another aspect of the invention, a quadrupole mass spectrometer is provided which includes first, second and third quadrupole rod sets arranged in sequence. The first quadrupole rod set is configured for isolating selected ions. The second quadrupole rod set is enclosed within a collision chamber having a background gas pressure significantly higher than that present in the first and second rod sets. The third quadrupole rod set is configured as a linear ion trap, and includes at least one set of poles straddling at least a portion of trapped ions. The trap has a background gas pressure of less than approximately 9×10⁻⁵ Torr. An alternating voltage source is provided for applying to at least one of the pole sets a resonant excitation signal for a period exceeding approximately 25 milliseconds, to thereby promote collision-induced dissociation of selected ions. The apparatus includes means for mass analyzing the trapped ions to generate a mass spectrum.

In the most preferred embodiments, the resonant excitation signal is applied for a period exceeding approximately fifty (50) milliseconds (ms) up to 2000 ms. The maximum amplitude of the resonant excitation signal (as experienced by the ions) is preferably limited to about 1 volt₍₀₋ₚₖ₎, although that value will vary depending on a variety of factors including the degree of ion ejection that results, as explained in greater detail below.

### BRIEF DESCRIPTION OF DRAWINGS

The foregoing and other aspects of the invention will become more apparent from the following description of specific embodiments thereof and the accompanying drawings which illustrate, by way of example only and not intending to be limiting, the principles of the invention. In the drawings:

FIG. 1 is a system block diagram of a mass spectrometer in accordance with a first embodiment;

FIG. 2 is a timing diagram showing, in schematic form, electrical signals applied to a quadrupole rod set in order to inject, trap, isolate, fragment and eject selected ions;

FIG. 3 shows a series of MS, MS² and MS³ spectrums obtained from a calibration peptide using the apparatus shown in FIG. 1;

FIG. 4 shows a series of mass spectrums illustrating the isotopic pattern of peptide fragments vs. resonant excitation frequency;

FIG. 5 is a graph which plots parent and fragment ion intensity for the peptide as a function of resonant excitation frequency;

FIG. 6 shows a series of MS and MS² spectrums obtained from reserpine ions using the apparatus shown in FIG. 1;

FIG. 7 is a detail view of certain portions of the plots shown in FIG. 6;

FIG. 8 is a graph which plots parent and fragment ion intensity of the reserpine ions as a function of resonant excitation amplitude;

FIG. 9 is a diagram illustrating how resolution of fragmentation is measured in the frequency domain;

FIG. 10 is a plot of a fragmentation of a 2722 m/z ion cluster, Agilent™ tuning solution, over varying excitation periods; and

FIG. 11 is a plot of the fragmentation of the Agilent™ 2722 m/z ion cluster over varying excitation amplitudes.

### DETAILED DESCRIPTION OF ILLUSTRATIVE EMBODIMENTS

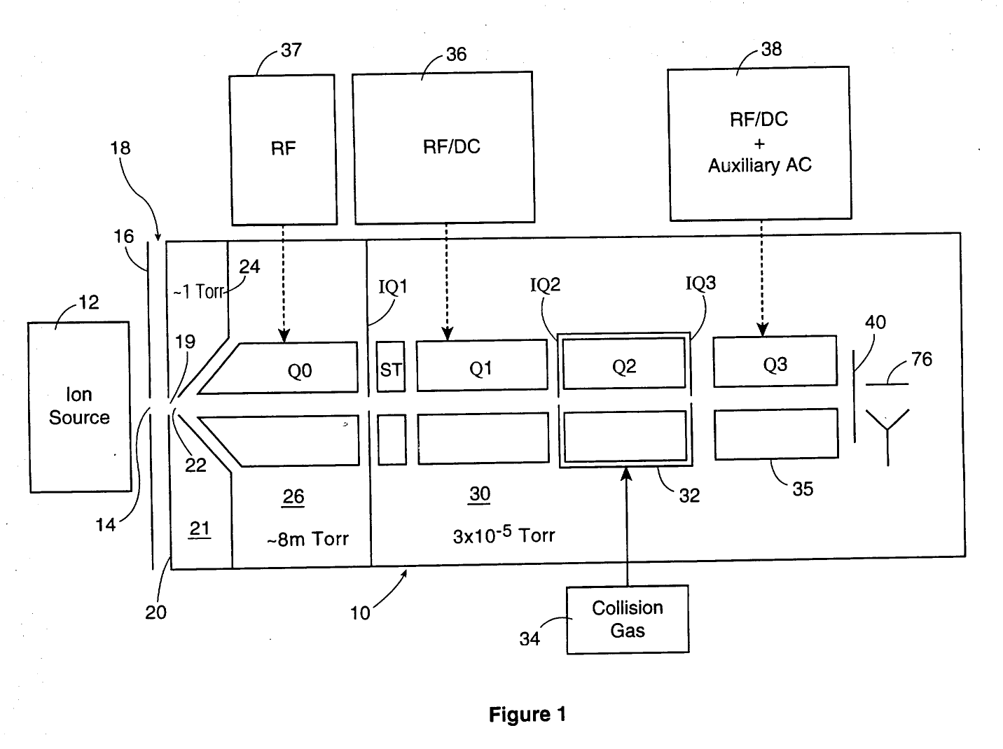

FIG. 1 illustrates a mass spectroscopy apparatus 10 in accordance with a first embodiment. In known manner, the apparatus 10 includes an ion source 12, which may be an electrospray, an ion spray, a corona discharge device or any other known ion source. Ions from the ion source 12 are directed through an aperture 14 in an aperture plate 16. On the other side of the plate 16, there is a curtain gas chamber 18, which is supplied with curtain gas from a source (not shown). The curtain gas can be argon, nitrogen or other inert gas, such as described in U.S. Pat. No. 4,861,988, to Cornell Research Foundation Inc., which also discloses a suitable ion spray device. The contents of this patent are incorporated herein by reference.

The ions then pass through an orifice 19 in an orifice plate 20 into a differentially pumped vacuum chamber 21. The ions then pass through aperture 22 in a skimmer plate 24 into a second differentially pumped chamber 26. Typically, the pressure in the differentially pumped chamber 21 is of the order of 1 or 2 Torr and the second differentially pumped chamber 26, often considered to be the first chamber of mass spectrometer, is evacuated to a pressure of about 7 or 8 mTorr.

In the chamber 26, there is a conventional RF-only multipole ion guide Q0. Its function is to cool and focus the ions, and it is assisted by the relatively high gas pressure present in chamber 26. This chamber 26 also serves to provide an interface between the atmospheric pressure ion source 12 and the lower pressure vacuum chambers, thereby serving to remove more of the gas from the ion stream, before further processing.

An interquad aperture IQ1 separates the chamber 26 from a second main vacuum chamber 30. In the second chamber 30, there are RF-only rods labeled ST (short for “stubbies”, to indicate rods of short axial extent), which serve as a Brubaker lens. A quadrupole rod set Q1 is located in the vacuum chamber 30, which is evacuated to approximately 1 to 3×10⁻⁵ Torr. A second quadrupole rod set Q2 is located in a collision cell 32, supplied with collision gas at 34. The collision cell 32 is designed to provide an axial field toward the exit end as taught by Thomson and Jolliffe in U.S. Pat. No. 6,111,250, the entire contents of which are incorporated herein by reference. The cell 32 is within the chamber 30 and includes interquad apertures IQ2, IQ3 at either end, and typically is maintained at a pressure in the range of about 5×10⁻⁴ to 10⁻² Torr, and more preferably to a pressure of about 5×10⁻³ to 10⁻² Torr. Following Q2 is located a third quadrupole rod set Q3, indicated at 35, and an exit lens 40. Opposite rods in Q3 are preferably spaced apart approximately 8.5 mm, although other spacings are contemplated and used in practice. The rods are preferably circular in cross-section as opposed to having hyperbolic profiles. The pressure in the Q3 region is nominally the same as that for Q1, namely 1 to 3×10⁻⁵ Torr. A detector 76 is provided for detecting ions exiting through the exit lens 40.

Power supplies 37, for RF, 36, for RF/DC, and 38, for RF/DC and auxiliary AC are provided, connected to the quadrupoles Q0, Q1, Q2, and Q3. Q0 is operated as an RF-only multipole ion guide whose function is to cool and focus the ions as taught in U.S. Pat. No. 4,963,736, the contents of which are incorporated herein by reference. Q1 is a standard resolving RF/DC quadrupole. The RF and DC voltages are chosen to transmit only precursor ions of interest or a range of ions into Q2. Q2 is supplied with collision gas from source 34 to dissociate or fragment precursor ions to produce a 1st generation of fragment ions. Q3 is operated as a modified linear ion trap which, in addition to trapping ions, may also used to both isolate and fragment a chosen ion as described in far greater detail below. Ions are then scanned out of Q3 in a mass dependent manner using an axial ejection technique.

In the illustrated embodiment, ions from ion source 12 are directed into the vacuum chamber 30 where, if desired, a precursor ion m/z (or range of mass-to-charge ratios) may be selected by Q1 through manipulation of the RF+DC voltages applied to the quadrupole rod set as well known in the art. Following precursor ion selection, the ions are accelerated into Q2 by a suitable voltage drop between Q1 and Q2, thereby inducing fragmentation as taught by U.S. Pat. No. 5,248,875 the contents of which are hereby incorporated by reference. The degree of fragmentation can be controlled in part by the pressure in the collision cell, Q2, and the potential difference between Q1 and Q2. In the illustrated embodiment, a DC voltage drop of approximately 10-12 volts is present between Q1 and IQ2.

The 1st generation of fragment ions along with non-dissociated precursor ions are carried into Q3 as a result of their momentum and the ambient pressure gradient between Q2 and Q3. A blocking potential is present on the exit lens 40 to prevent escape of the ions. After a suitable fill time a blocking potential is applied to IQ3 in order to trap the precursor ions and 1st generation fragments in Q3, which functions as a linear ion trap.

Once trapped in Q3, the precursor ions and 1st generation of fragment ions may be mass isolated to select a specific m/z value or m/z range. Then, selected ions may be resonantly excited in the low pressure environment of Q3 as described in greater detail below to produce a 2nd generation of fragment ions (i.e., fragments of fragments) or selected precursor ions may be fragmented. Ions are then mass selectively scanned out of the linear ion trap, thereby yielding an MS³ or MS² spectrum, depending on whether the 1st generation fragments or the precursor ions are dissociated in Q3. It will also be appreciated that the cycle of, isolating, and fragmenting can be carried out one or more times to thereby yield an MSⁿ spectrum (where n>3).

As described in greater detail below, the selectivity or resolution of isolating and fragmenting ions in the low pressure environment of Q3 may be sufficiently high for many purposes. Accordingly, it will be understood that Q1, used for isolating precursor ions, can be omitted if desired, since this activity may be carried out in Q3, albeit not to the same degree of resolution. Similarly, the Q2 collision cell may be omitted since the step of fragmenting ions can occur entirely within the confines of the linear trap, Q3, with much higher resolution than within Q2. Indeed, the linear ion trap suitably coupled to an ion source may be used to generate an MS², MS³ or higher spectrum.

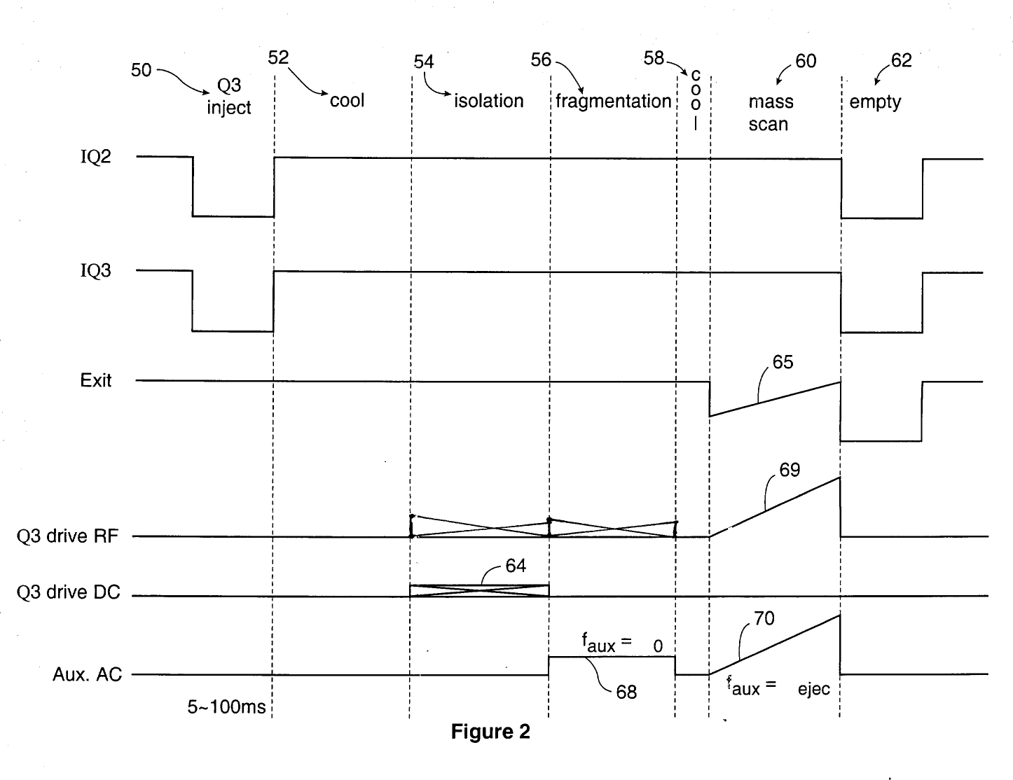

FIG. 2 shows the timing diagrams of the waveforms applied in Q3 in greater detail. In an initial phase 50, the blocking potential on IQ3 is dropped so as to permit the trap to fill for a time preferably in the range of approximately 5-100 ms, with 50 ms being preferred.

Next, a cooling phase 52 follows in which the precursor and 1st generation ions are allowed to cool or thermalize for a period of about 10-150 ms in Q3. The cooling phase is optional, and may be omitted in practice.

This is followed by an ion isolation phase 54, if isolation is desired. Ion isolation in Q3 can be effected by a number of methods, such as the application of suitable RF and DC signals to the quadruple rods of Q3 in order to isolate a selected ion at the tip of a stability region or ions below a cut-off value. In this process, selected m/z ranges are made unstable because their associated a,q values fall outside the normal Mathieu stability diagram. This is the preferred method because the mass resolution of isolation using this technique is known to be relatively high. In the illustrated system, the frequency of the RF signal remains fixed, with the amplitudes of the RF signal and the DC offset being manipulated (as schematically illustrated by ref. no. 64) to effect radial ejection of unwanted ions. The auxiliary AC voltage component is not active during the isolation phase in the illustrated system. This phase lasts approximately <5 ms, and may be as short as 0.1 ms.

Alternatively, isolation can be accomplished through resonant ejection techniques which can be employed to radially eject all other ions such as disclosed, inter alia, in WIPO Publication No. WO 00/33350 dated Jun. 8, 2000 by Douglas et al., the contents of which are incorporated herein by reference. In the Douglas publication, the auxiliary AC voltage is controlled to generate a notched broadband excitation waveform spanning a wide frequency range, created by successive sine waves, each with a relatively high amplitude separated by a frequency of 0.5 kHz. The notch in the broadband waveform is typically 2 -10 kHz wide and centered on the secular frequency corresponding to the ion of interest. The isolation phase according to this technique lasts for approximately 4 ms.

Other ion isolation techniques are also contemplated since the particular means is not important, provided sufficient resolution is obtainable. It should be appreciated that isolation via resonant excitation techniques may be acceptable for many purposes because the resolution is relatively high as a result of the ions being trapped in a relatively low pressure environment. Consequently, as elaborated on in greater detail below, the spread or variation in secular frequencies of ions having identical m/z values is relatively low, thus enabling higher discrimination.

The isolation phase 54 is followed by a fragmentation phase 56 in which a selected ion is fragmented. During this phase 56 the auxiliary AC voltage, which is superimposed over the RF voltage used to trap ions in Q3, is applied to one set of pole pairs, in the x or y direction. The auxiliary AC voltage (alternatively referred to as the “resonant excitation signal”), thus creates an auxiliary, dipolar, alternating electric field in Q3 (which is superimposed over the RF electric fields employed to trap ions). This subjects the trapped ions to an alternating potential whose maximum value is encountered immediately adjacent to the rods.

Application of the auxiliary AC voltage at the resonant frequency of a selected ion causes the amplitude of its oscillation to increase. If the amplitude is greater than the radius of the pole pair, the ion will be radially ejected from Q3 or neutralized by the rods. Alternatively, an energetic ion could collide with a background gas molecule with the energy being converted into sufficient internal energy required to cause the ion to dissociate and produce fragment ions. The inventors have discovered that through suitable manipulation of the excitation voltage and its period of application, it is possible to generate a sufficient number of ion/background gas collisions for CID to occur at a reasonably practical fragmentation efficiency even in the very low pressure environment of Q3, where the background gas pressure is preferably on the order of 10⁻⁵ Torr. This was previously thought to be too low of a pressure for this phenomenon to occur for practical use in mass spectroscopy. As an added benefit, the inventors have found that the resolution of fragmentation can be relatively high, about 700 as determined from experimental data discussed below, which is 2-3 times that previously reported in the literature.

It is also preferred to use rod sets in Q3 which are not perfectly hyperbolic in cross-section. For example, the preferred embodiment employs rods which are circular in cross-section. The application of the resonant excitation signal causes ions to oscillate in the radial direction, causing the ions to travel further and further away from the central longitudinal axis of the trap. In a non-hyperbolic rod set, the resonant excitation signal affects the ion less the further it is away from the central longitudinal axis due to the non-ideal quadrupolar fields provided by such rods. In effect, the non-ideality of the quadrupolar field acts as a damper on the oscillatory movement, causing less ions to eject radially in a given time frame and hence affording ions a greater opportunity to dissociate by collision with the background gas molecules.

In the illustrated embodiment, the resonant excitation signal is a sinusoid having an amplitude that ranges up to approximately 1 volt, measured zero to peak (0-pk), and preferably in the range of approximately 10 mV₍₀₋ₚₖ₎ to approximately 550 mV₍₀₋ₚₖ₎, the latter value being found to be generally sufficient for disassociating most of the more tightly coupled bonds found in biomolecules. In practice, a preset amplitude of approximately 24 -25 mV₍₀₋ₚₖ₎ has been found to work well over a wide range of m/z values.

The frequency of the resonant excitation signal fₐᵤₓ (68) is preferably set to equal the fundamental resonant frequency, Z₀, of the ion selected for fragmentation. Z₀ is unique for each m/z and approximated to a close degree by:

$${Z}_{0} \frac{{q}_{u}}{\sqrt{8}} :$$

where: is the angular frequency of the trapping RF signal. This approximation is valid for q_{x,y}≦0.4 in an RF-only quadrupole. In the illustrated embodiment Q3 is operated at a q of approximately 0.21 in the x and y planes.

The resonant excitation signal is applied for a period exceeding about 25 milliseconds (ms), and preferably at least approximately 50 ms ranging up to 2000 ms. In practice, an application period of 50 ms has been found to work well over a wide range of m/z values.

Fragmentation efficiency (defined as the sum of all fragment ions divided by the number of initial parent ions) can reach as high as about 70-95% under the preferred operating parameters for certain ions, as shown by the experimental results discussed below.

Following fragmentation, the ions are preferably subjected to an additional cooling phase 58 of approximately 10 ms to allow the ions to thermalize. This phase may be omitted if desired.

A mass scan or mass analysis phase 60 follows the cooling phase. Here, ions are axially scanned out of Q3 in a mass dependent manner preferably using an axial ejection technique as generally taught in U.S. Pat. No. 6,177,668, the contents of which are incorporated herein by reference. Briefly, the technique disclosed in U.S. Pat. No. 6,177,668 relies upon injecting ions into the entrance of a rod set, for example a quadrupole rod set, and trapping the ions at the far end by producing a barrier field at an exit member. An RF field is applied to the rods, at least adjacent to the barrier member, and the RF fields interact in an extraction region adjacent to the exit end of the rod set and the barrier member, to produce a fringing field. Ions in the extraction region are energized to eject, mass selectively, at least some ions of a selected mass-to-charge ratio axially from the rod set and past the barrier field. The ejected ions can then be detected. Various techniques are taught for ejecting the ions axially, namely scanning an auxiliary AC field applied to the end lens or barrier, scanning the RF voltage applied to the rod set while applying a fixed frequency auxiliary voltage to the end barrier and applying a supplementary AC voltage to the rod set in addition to that on the lens and the RF on the rods.

The illustrated embodiment employs a combination of the above techniques. More particularly, the DC blocking potential 65 applied to the exit lens 40 is lowered somewhat, albeit not removed entirely, and caused to ramp over the scanning period. Simultaneously, both the Q3 RF voltage 69 and the Q3 auxiliary AC voltage 70 are ramped. In this phase, the frequency of the auxiliary AC voltage is preferably set to a predetermined frequency ω_{ejec} known to effectuate axial ejection. (Every linear ion trap may have a somewhat different frequency for optimal axial ejection based on its exact geometrical configuration.) The simultaneous ramping of the exit barrier, RF and auxiliary AC voltages increases the efficiency of axially ejecting ions, as described in greater detail in assignee's co-pending U.S. patent application Ser. No. 10/159,766 filed May 30, 2002, entitled Improved Axial Ejection Resolution in Multipole Mass Spectrometers, the contents of which are incorporated herein by reference.

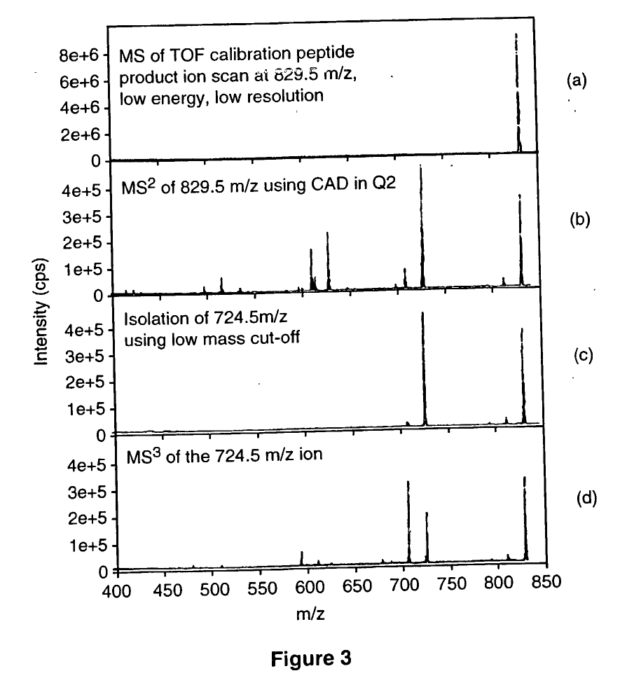

Some experimental data using the aforementioned apparatus is now discussed with reference to FIGS. 3-8. FIG. 3 shows a number of mass spectrums, labeled (a)-(d), each of which relates to a standardized calibration peptide (5 π/min, infusion mode). FIG. 3(a) is a high resolution MS spectrum wherein the peptide at m/z 829.5 was isolated using resolving RF/DC in Q1 (set at low resolution) and the ion was injected into the Q2 collision cell at low energy to minimize fragmentation. The neutral gas (nitrogen) pressure in the collision cell, Q2, was about 5-10 mtorr. The spectrum (and all other spectrums in FIG. 3) was obtained using the preferred axial ejection scanning technique in Q3 as described above. FIG. 3(b) shows the MS² spectrum of the peptide as it was driven with relatively high injection energy into the Q2 collision cell. FIG. 3(c) shows the isolation of high mass ions using a low mass cut-off technique in Q3 to remove most ions below a peak of interest at m/z=724.5. FIG. 3(d) is an MS³ spectrum showing resonant excitation of ions at m/z=724.5. To produce this spectrum the resonant excitation signal was set to a frequency of 60.37 kHz and an excitation amplitude of 24 mV₍₀₋ₚₖ₎. The excitation period was 100 ms. The neutral gas pressure in Q3 was 2.7×10⁻⁵ Torr as measured at the chamber wall. (The Q3 quadrupole was not enclosed in a cell so this pressure is probably accurate to within a factor of 2-3 for the ambient pressure within Q3.) Note the increase in intensity of the peak at m/z=706 and the decrease in intensity of the m/z=724.5 peak in the MS³ spectrum of FIG. 3(d) as compared to the MS² spectrum shown in FIG. 3(b).

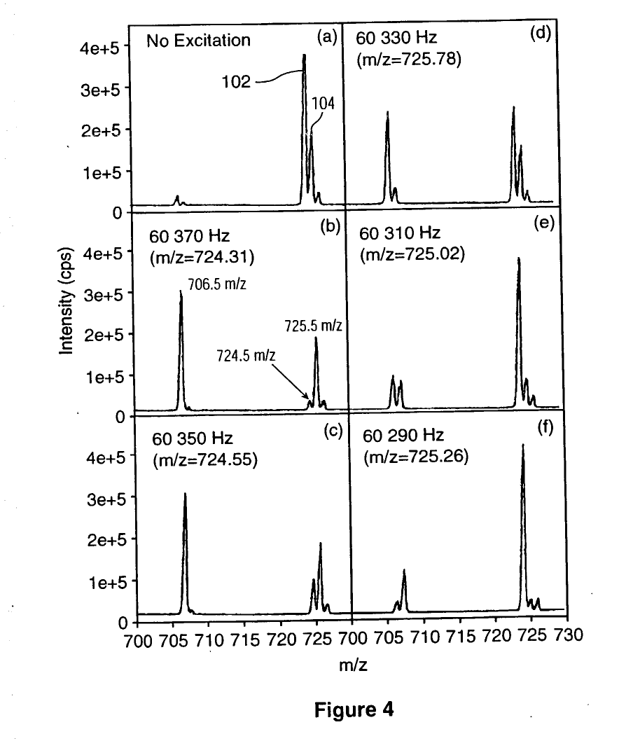

FIG. 4 shows high resolution spectrums labeled (a)-(f) of 1st and 2nd generation fragments of the peptide as the excitation frequency is varied. FIG. 4(a) shows an MS² spectrum of 1st generation ions, i.e., wherein the ions are not resonantly excited. Note that the fragmentation resulting from the Q2 collision cell reveals two closely spaced fragment isotopes 102 and 104 at m/z=724.5 and at m/z=725.5. FIG. 4(b) shows the spectrum when the ions are resonantly excited at a frequency of 60.370 kHz (24 mV₍₀₋ₚₖ₎, excitation period 100 ms). The m/z=724.5 ion has almost completely dissociated and the m/z peak at 706.5 is at its maximum intensity. As the frequency of excitation is decreased, the dissociation of the m/z ion at 724.5 decreases, as shown in FIGS. 4(c), 4(d), 4(e) and 4(f). When the excitation frequency reaches 60.310 kHz, the isotope 104 at m/z=725.5 begins to demonstrate visible signs of dissociation, and is substantially dissociated when the excitation frequency reaches 60.290 kHz, as shown in the spectrum of FIG. 4(f). The system thus allows the user to selectively fragment ions 1 m/z units apart, i.e., the apparatus exhibits a discrimination of at least 1 m/z unit, at m/z=725. Given such selectivity, it will be appreciated that a non-fragmented isotope can be used to calibrate the spectrometer. In particular, the m/z value of the non-fragmented isotope can be compared to the m/z value prior to the fragmentation step. Any change in the m/z value can be used to identify and correct for mass drift of the instrument. Comparing the intensities of the non-fragmented isotope can also be used to correct for intensity variation.

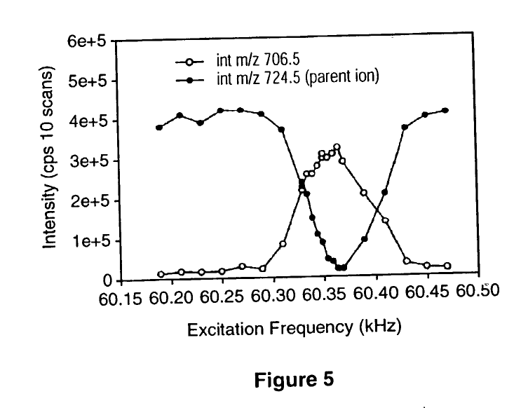

FIG. 5 shows the intensity of a parent ion (the peptide fragment at m/z 724.5) and its fragment ion (the 2^{nd} generation peptide fragment at m/z 706.5) as a function of the excitation frequency (24 mV₍₀₋ₚₖ₎, 100 ms excitation). The full width half maximum value (FWHM) of the parent ion intensity is 77 Hz. This gives a resolution of 784 (60360 Hz/77 Hz). The FWHM of the fragment is 87 Hz giving a resolution of 694. The fragmentation efficiency for the 724.5 to 706.5 dissociation is thus 73%. The overall fragmentation efficiency will be even higher when one considers that not all the fragment ions are m/z=706.5, as can be seen from the spectrum of FIG. 3(d).

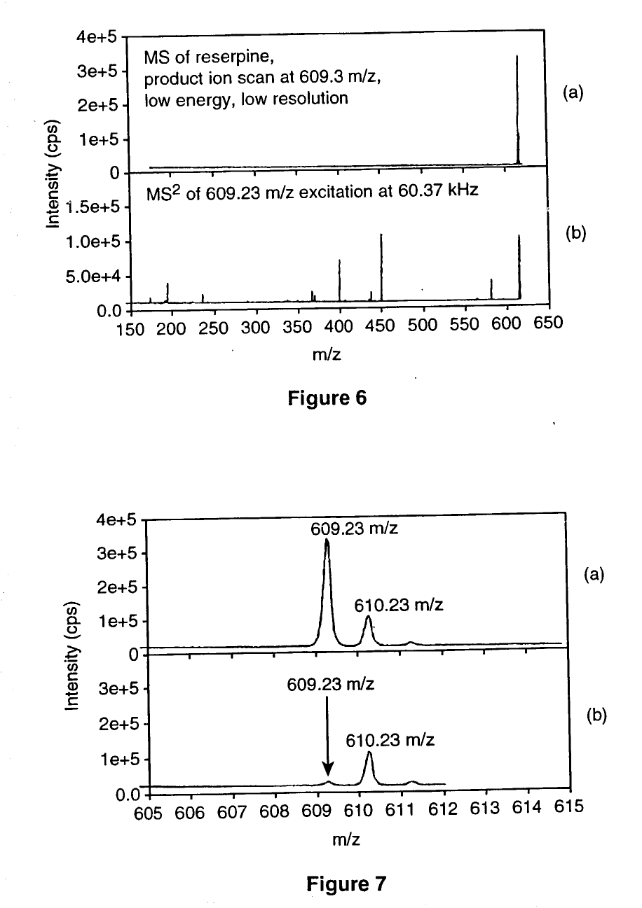

FIG. 6 shows mass spectrums, labeled (a) and (b), of reserpine (100 pg/π, 5-10 π/min, infusion mode). FIG. 6(a) is a high resolution mass spectrum of reserpine isolated in Q1 (set at low resolution) and injected at low energy into the collision cell Q2 and then into Q3 where the ions were trapped. No excitation was applied for 100 ms. The ions were then scanned out using the aforementioned preferred axial ejection technique. FIG. 6(b) shows an MS² spectrum after the reserpine ions were resonantly excitated using a 60.37 kHz, 21 mV₍₀₋ₚₖ₎ resonant excitation signal over a 100 ms excitation period. The integrated intensity of the m/z 609.23 peak in FIG. 6(a) is 1.75e6 cps while the integrated intensity of the fragment ions in FIG. 6(b) is 1.63e6 cps. This gives a fragmentation efficiency of 93%. FIG. 7 shows the region from 605 to 615 m/z of the plots in FIG. 5 in greater detail. This shows that only the m/z 609.23 peak was selected for dissociation.

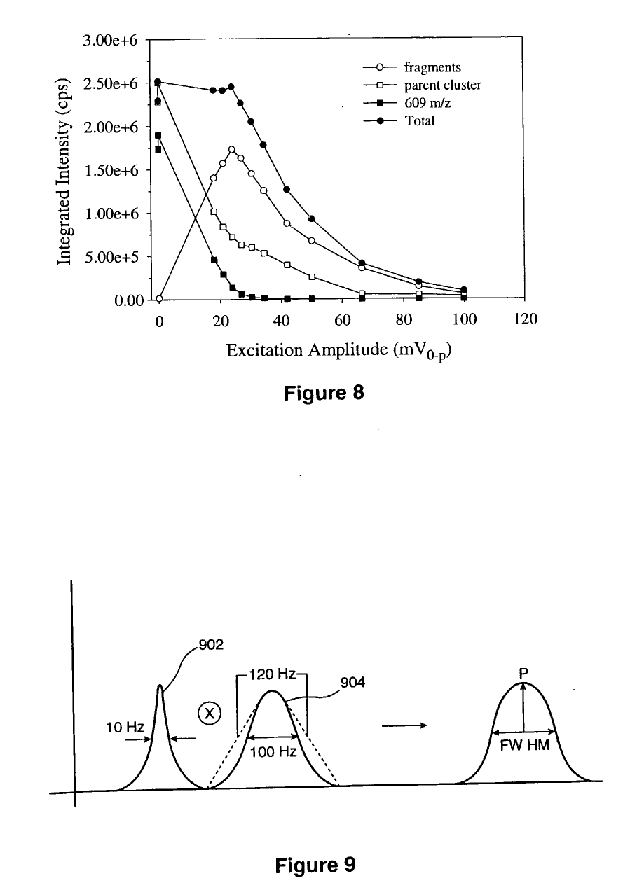

FIG. 8 shows the intensity of reserpine fragments (dissociated from parent ion m/z=609.23) as a function of excitation amplitude, the excitation frequency being set to 60.37 kHz, q=0.2075, t=100 ms, with neutral gas pressure in Q3 being approximately 2.7×10⁻⁵ Torr as measured in the chamber. The plots reach a maximum and then begin to decline in intensity as ejection of the ions from the linear ion trap, Q3, begins to become significant.

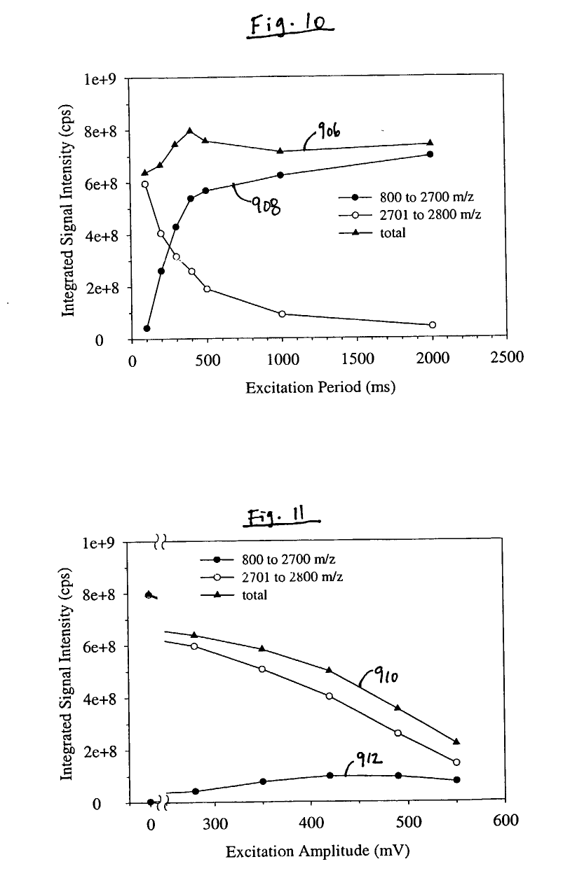

Fragmentation efficiency appears to depend on a variety of factors, including the exact shape or profile of the rod sets employed, the q factor, and the particular type of ion that is being fragmented, and the amplitude of the resonant excitation signal. For example, FIG. 10 shows a plot of the fragmentation of an Agilent™ tuning solution component, comprising an ion cluster centered at 2722 m/z, over varying excitations periods. This plot was taken using an instrument similar to that shown and described with reference to FIG. 1. The excitation frequency was 59.780 kHz, at an excitation amplitude of 280 mV, with the instrument operated at a q of 0.205. Note how the fragmentation efficiency increases rapidly (as indicated by plot 908) up to an excitation period of about 500 ms, after which there is not a significant gain in efficiency. Ejection appears to be relatively constant, as indicated by the relatively flat profile of plot 906.

FIG. 11 plots the fragmentation of the 2722 m/z ion as a function of excitation amplitude. In this data the excitation frequency was 59.780 kHz applied for a period of 100 ms, the instrument being likewise operated at a q of 0.205. The data shows that a higher amplitudes, the intensity of the 2722 m/z cluster and its fragments, indicated by plot 910, dips considerably, implying increasing ejection of ions. However, fragmentation efficiency, indicated by plot 912, appears to increase slightly. By extrapolating plots 910 and 912 it appears that a practically significant fragmentation efficiency can be achieved at excitation amplitudes as high as a 1 volt₍₀₋ₚₖ₎.

The plots in FIGS. 10 and 11 indicate that the total power applied to ions can be controlled by increasing the excitation period, or increasing the excitation amplitude. In general, it is preferred to minimize the fragmentation time, which generally requires a higher excitation amplitude, subject to acceptable ejection losses.

Although not intending to be bound by the following theory, it is believed that the relatively high resolution of fragmentation is achieved because resonant excitation takes place in a relatively low pressure environment. Calculations have indicated that the spread or variation in ions secular frequency at this low pressure is approximately 100 Hz. The excitation period is relatively long, typically exceeding 50 ms. As shown in FIG. 9, resolution can be understood from the convolution of two signals 902 and 904 in the frequency domain. Signal 902 represents the excitation pulse. At 100 ms, the excitation pulse has a FWHM spread of about 10 Hz as determined by its Fourier transform. Signal 904 represents the variation in the secular frequency, which has a spread of about 100 Hz. Resolution can be measured by convolving these two signals and measuring the frequency of the product signal divided by FWHM value.

While the illustrated embodiment has been described with a certain degree of particularity for the purposes of description, it will be understood that a number of variations may be made which nevertheless still embody the principles of the invention. For example, the frequency of the resonant excitation signal has been described as equal to the fundamental resonant frequency Z₀ of the ion selected for fragmentation. In alternative embodiments the excitation frequency can be stepped or otherwise varied through a range of frequencies about or near Z₀ over the excitation period. This would ensure that all closely spaced isotopes of an ion are dissociated, if desired. The frequencies could be stepped through discretely, as exemplified by the 20 Hz increments in FIG. 4, or continuously over the excitation period. The range could be preset, for example, ±0.5% of Z₀ or some other pre-determined percentage. Alternatively, the range could be a user-set parameter. The amplitude voltage may be similarly stepped or varied over the excitation period up to a certain point, as exemplified in FIG. 8.

It will also be appreciated that while excitation frequency in preferred embodiments is set at the fundamental resonant frequency Z₀ of the ion selected for fragmentation, a harmonic of the fundamental resonant frequency could be used in the alternative to resonantly excite the selected ion. In this case, the excitation signal may require a higher amplitude or longer excitation period.

In the illustrated embodiment the auxiliary AC excitation signal has been described as being applied to one of the pole pairs constituting the trap. It will be understood that the excitation signal may be applied to both pole pairs, thus subjecting the trapped ions to an auxiliary oscillating quadrupolar potential. Furthermore, it should be sufficient for at least one of the rods to be non-hyperbolic in cross-section so as to provide an approximate, albeit non-ideal quadrupolar field. It will also be understood that the excitation signal need not be applied to the rods of the linear ion trap itself. Rather, additional rods or other types of structures can be employed to subject the trapped ions to an alternating dipolar, quadrupolar or higher order potential field in order to resonantly excite selected ions.

In addition, it will be appreciated that the maximum amplitude of the resonant excitation signal that can be applied to the pole pair(s) to reach a practical fragmentation efficiency—typically considered at that level which yields three times the signal to noise ratio—may vary considerably depending on a number of factors. These factors include: the inter-pole distance; the distance between the poles and the central longitudinal axis; the shape or profile of the poles; the strength of the molecular bonds; and the collision cross-section of the background gas molecule.

Furthermore, while the illustrated embodiment has disclosed the low pressure fragmentation as being conducted within the confines of a linear (2-D) trap, in theory there is no reason why the fragmentation cannot be conducted within a quadrupole (3-D) ion trap. In practice, however, it is difficult to construct a quadrupole (3-D) ion trap capable of operating at ambient pressures on the order of 10⁻⁵ Torr. This is because such traps typically have a relatively small volume but must have sufficient inert gas therein to slow down ions injected into the trap before the RF/DC fields can perform its trapping function. With 3-D traps, ions are injected typically through the ring element. The RF applied to the ring element becomes a barrier field that ions must overcome. So, ions must be energetic to overcome this barrier. The high pressure in the 3-D trap is required to cool the energetic ions. With too low a pressure, too few ions are damped and held in the trap. Too high a pressure and the injected ions may be lost due to collisional scattering. Such traps thus typically operate at ambient pressures on the order of 10⁻³ Torr, which limits the obtainable isolation and fragmentation resolutions. On the other hand, the 2-D linear ion trap such as Q3 has an elongated length which provides sufficient axial distance for the ions to collide with a smaller amount of the background gas needed to provide the necessary damping effect prior to trapping. More particularly, ions are injected along the length of the rods of a 2-D trap. During injection, there is no barrier—or the DC on the entrance barrier element is small such that the ions are not required to be too energetic. Nevertheless, the ions have some energy that requires axial distance for collisional cooling. During the fill period, ions traveling along the length and reflected back, due to the exit barrier element, have lost considerable energy. The small amount of DC on the entrance barrier element is sufficient to reflect these ions and prevent them from exiting at the entrance. Once trapping is achieved, resonant excitation can be applied to the thermalized ions to induce either dissociation or ejection as described above.

It will also be understood that a variety of mechanisms can be used for the mass scanning phase after ions are fragmented in the low pressure environment. For example, another mass resolving quadrupole could be installed after the low pressure fragmentation trap such as Q3. Similarly, another 2-D or 3-D trap could be installed after Q3. Alternatively, the low pressure fragmentation trap could be coupled to a time of flight (TOF) device in order to obtain a mass spectrum.

Finally, it will be understood that the background gas pressures, excitation amplitudes and excitation periods discussed herein with reference to the preferred embodiments are illustrative only and may be varied outside of the disclosed ranges without a noticeable decrease in performance as measured by the selectivity or resolution of fragmentation. None of the embodiments or operating ranges disclosed herein is intended to signify any absolute limits to the practice of the invention. Those skilled in the art will appreciate that numerous other modifications and variations may be made to the embodiments disclosed herein without departing from the spirit of the invention.

We claim:

1. A method of fragmenting ions, comprising:
a) trapping ions in an ion trap, the trap being disposed in an environment in which a background gas is present at a pressure of less than approximately 9×10⁻⁵ Torr; and
b) resonantly exciting selected trapped ions for an excitation period exceeding approximately 25 milliseconds, to thereby promote collision-induced dissociation of at least a portion of the trapped ions.

2. A method according to claim 1, wherein the selected trapped ions are resonantly excited by subjecting them to an alternating potential that has a maximum amplitude of less than approximately 1 volt₍₀₋ₚₖ₎.

3. A method according to claim 1, wherein the pressure is in the range of approximately 1×10⁻⁵ Torr and approximately 9×10⁻⁵ Torr.

4. A method according to claim 2, wherein the alternating potential has a maximum amplitude of 500 mV₍₀₋ₚₖ₎.

5. A method according to claim 4, wherein the amplitude of the auxiliary alternating potential is approximately 25 mV₍₀₋ₚₖ₎.

6. A method according to claim 1, wherein the excitation period is in the range of approximately 50 milliseconds to approximately 2000 milliseconds.

7. A method according to claim 6, wherein the excitation period is in the range of approximately 50 to 500 milliseconds.

8. A method according to claim 1, wherein the selected trapped ions are resonantly excited by subjecting them to an alternating potential that has a frequency component substantially equal to a fundamental resonant frequency of a selected ion, the maximum amplitude of said component being less than approximately 1 V₍₀₋ₚₖ₎.

9. A method according to claim 8, wherein the background gas pressure is in the range of approximately 1×10⁻⁵ Torr and approximately 9×10⁻⁵ Torr.

10. A method according to claim 8, wherein the excitation period is in the range of approximately 50 milliseconds to approximately 2000 milliseconds.

11. A method according to claim 10, wherein the excitation period is in the range of approximately 50 to approximately 500 milliseconds.

12. A method according to claim 9, wherein the amplitude of said component is in the range of approximately 10 mV₍₀₋ₚₖ₎ to approximately 500 mV₍₀₋ₚₖ₎.

13. A method according to claim 12, wherein the amplitude of said component is approximately 25 mV₍₀₋ₚₖ₎.

14. A method according to any of claims 1, 2, 3, 4, 6 and 8, wherein the ion trap provides a non-ideal quadrupolar field for trapping ions.

15. A method of fragmenting ions, comprising:
c) trapping ions in an ion trap by subjecting the ions to an RF alternating potential, the trap being disposed in an environment in which a background gas is present at a pressure of less than approximately 9×10⁻⁵ Torr;
d) resonantly exciting trapped ions of a selected m/z value or valves by applying to at least one set of poles straddling the trapped ions an auxiliary alternating excitation signal for a period exceeding approximately 25 milliseconds, to thereby promote collision-induced dissociation of the selected ions.

16. A method according to claim 14, wherein the excitation signal has an amplitude of less than approximately 1V₍₀₋ₚₖ₎.

17. A method according to claim 16, wherein the ion trap includes one or more poles that have non-hyperbolic cross-sections.

18. A method according to claim 17, wherein said poles have substantially circular cross-sections.

19. A method according to claim 16, wherein the excitation signal has a frequency substantially equal to a fundamental resonant frequency of the selected ions or a harmonic thereof.

20. A method according to claim 17, wherein the frequency of the excitation signal is varied through a pre-determined range encompassing the fundamental resonant frequency of the selected ions or a harmonic thereof.

21. A method according to claim 16, wherein the ion trap is a linear ion trap comprising two pole sets, the excitation signal being applied to only one pole set.

22. A method according to claim 20, wherein the background gas pressure is on the order of 10⁻⁵ Torr.

23. A method according to claim 22, wherein the amplitude of the excitation signal is in the range of approximately 10 mV₍₀₋ₚₖ₎ to approximately 500 mV₍₀₋ₚₖ₎.

24. A method according to claim 23, wherein the excitation period is in the range of approximately 50 to 2000 milliseconds.

25. A method according to claim 23, wherein the frequency of the excitation signal is varied through a pre-determined range encompassing the fundamental resonant frequency of the selected ions or a harmonic thereof

26. A method according to claim 16, wherein the ion trap is a linear ion trap comprising two pole sets, the excitation signal being applied to both pole sets.

27. A method according to claim 26, wherein the background gas pressure is on the order of 10⁻⁵ Torr.

28. A method according to claim 27, wherein the amplitude of the excitation signal is in the range of approximately 10 mV₍₀₋ₚₖ₎ to approximately 500 mV₍₀₋ₚₖ₎.

29. A method according to claim 28, wherein the excitation period is in the range of approximately 50 to 2000 milliseconds.

30. A method according to claim 23, wherein the frequency of the excitation signal is varied through a pre-determined range encompassing the fundamental resonant frequency of the selected ions or a harmonic thereof.

31. A method according to claim 16, including mass analyzing the fragmented ions to obtain a mass spectrum.

32. A method of mass analyzing a stream of ions, the method comprising:
a) subjecting a stream of ions to a first mass filter step, to select precursor ions having a mass-to-charge ratio in a first desired range;
b) trapping the precursor ions in a linear ion trap by subjecting the ions to an RF alternating potential;
c) resonantly exciting selected trapped precursor ions by subjecting them to an auxiliary alternating potential having a maximum amplitude of less than approximately 1V₍₀₋ₚₖ₎ for an excitation period exceeding approximately 50 milliseconds under a background gas pressure of less than 9×10⁻⁵ Torr, to thereby generate fragment ions; and
d) mass analyzing the trapped ions to generate a mass spectrum.

33. A method according to claim 32, wherein the linear ion trap includes one or more poles that are non-hyperbolic in cross-section.

34. A method according to claim 32, including, before step (d):
a) subjecting the trapped ions to a second mass filter step in order to isolate ions having an m/z value(s) in a second desired range, and
b) repeating step (c).

35. A method according to claim 32, wherein the pressure is on the order of 10⁻⁵ Torr.

36. A method according to claim 32, wherein the excitation period is in the range of approximately 50 to approximately 2000 milliseconds.

37. A method according to claim 32, wherein the amplitude of the auxiliary alternating potential is in the range of approximately 10 mV₍₀₋ₚₖ₎ to approximately 500 mV₍₀₋ₚₖ₎.

38. A method of mass analyzing a stream of ions, the method comprising:
a) subjecting a stream of ions to a first mass filter step, to select precursor ions having a mass-to-charge ratio in a first desired range;
b) fragmenting the precursor ions in a collision cell, to thereby produce a first generation of fragment ions;
c) trapping any un-dissociated precursor ions and the first generation of fragment ions in a linear ion trap by subjecting the ions to an RF alternating potential, and:
(i) subjecting the trapped ions to a second mass filter step, to thereby isolate ions having an m/z value(s) in a second desired range,
(ii) resonantly exciting selected first generation ions by subjecting them to an auxiliary alternating potential for an excitation period exceeding approximately 25 milliseconds under a background gas pressure of less than about 9×10⁻⁵ Torr, to thereby generate a second generation of fragment ions, and
d) mass analyzing the trapped ions to generate a mass spectrum.

39. A method according to claim 38, wherein the alternating potential has a maximum amplitude of approximately 1V₍₀₋ₚₖ₎.

40. A method according to claim 38, wherein the linear ion trap includes one or more poles for applying the alternating potential that are non-hyperbolic in cross-section.

41. A method according to claim 38, including repeating steps (c)(i) and (c)(ii) to thereby generate subsequent generations of fragment ions.

42. A method according to claim 38, wherein the pressure is on the order of 10⁻⁵ Torr.

43. A method according to claim 38, wherein the excitation period is in the range of approximately 50 to approximately 2000 milliseconds.

44. A method according to claim 39, wherein the amplitude of the auxiliary alternating potential is in the range of approximately 10 mV₍₀₋ₚₖ₎ to approximately 500 mV₍₀₋ₚₖ₎.

45. A method of mass analyzing a stream of ions, the method comprising:
a) subjecting a stream of ions to a first mass filter step, to select precursor ions having a mass-to-charge ratio in a first desired range;
b) fragmenting the precursor ions in a collision cell, to thereby produce a first generation of fragment ions;
c) trapping any un-dissociated precursor ions and the first generation of fragment ions in a linear ion trap, and:
(i) subjecting the trapped ions to a second mass filter step, to thereby isolate ions having an m/z value(s) in a second desired range,
(ii) resonantly exciting trapped ions of a selected m/z value or values by applying to at least one set of poles straddling the trapped ions an alternating excitation signal for a period exceeding approximately 25 milliseconds, to thereby promote collision-induced dissociation of the selected ions, and
d) mass analyzing the trapped ions to generate a mass spectrum.

46. A method according to claim 45, wherein the excitation signal has an amplitude of less than approximately 1V₍₀₋ₚₖ₎

47. A method according to claim 45, wherein excitation signal is applied to poles that have non-hyperbolic cross-sections.

48. A mass spectrometer, comprising:
a linear ion trap, including at least one set of poles straddling at least a portion of trapped ions;
means for providing a background gas in said trap at a pressure of less than approximately 9×10⁻⁵ Torr;
means for introducing ions into said trap;
an alternating voltage source for applying to said at least one of set of poles a resonant excitation signal for a period exceeding approximately 25 milliseconds in order to promote collision-induced dissociation of selected ions; and
means for mass analyzing the trapped ions to generate a mass spectrum.

49. A mass spectrometer according to claim 48, wherein the resonant excitation signal has an amplitude of less than approximately 1V₍₀₋ₚₖ₎.

50. A mass spectrometer according to claim 48, wherein each of said at least one pair of poles have non-hyperbolic profiles.

51. A mass spectrometer according to claim 50, wherein said at least one set of poles is not used to trap said ions in said trap.

52. A triple quadrupole mass spectrometer, comprising:
first, second and third quadrupole rod sets arranged in sequence;
said first quadrupole rod set being configured for isolating selected ions;
said second quadrupole rod set being enclosed within a collision chamber having a background gas pressure significantly higher than the first and second rod sets;
said third quadrupole rod set being configured as a linear ion trap, including at least one set of poles straddling at least a portion of trapped ions, the trap having a background gas pressure of less than approximately 9×10⁻⁵Torr;
an alternating voltage source for applying to said at least one set of poles a resonant excitation signal having an amplitude of less than approximately 1V₍₀₋ₚₖ₎ for a period exceeding approximately 25 milliseconds in order to promote collision-induced dissociation of selected ions; and
means for mass analyzing the trapped ions to generate a mass spectrum.

53. A mass spectrometer according to claim 52, wherein said at least one set of poles is not used to trap said ions in said third quadrople rod set.

54. The mass spectrometer according to claim 52, wherein the third quadrupole rod set has poles that each have a non-hyperbolic cross-sectional profile.
